(19) United States
(12) Patent Application Publication
(10) Pub. No.: US 2026/0304506 A1
(43) Pub. Date: Oct. 1, 2026

(54) Radio Network Node, Remote Device, Relay Device and Methods Performed Therein

(71) Applicant: Telefonaktiebolaget LM Ericsson (publ), Stockholm (SE)

(72) Inventors: Bikramjit Singh, Raasepori (FI); Min Wang, Luleå (SE)

(21) Appl. No.: 19/477,224

(22) PCT Filed: Apr. 26, 2024
(86) PCT No.: PCT/SE2024/050402

§ 371 Date: Oct. 21, 2025

Related U.S. Application Data
(60) Provisional application No. 63/498,833, filed on Apr. 28, 2023.

(51) Int. Cl. H04W 76/10; H04W 88/04

(52) U.S. Cl. CPC H04W 76/10; H04W 88/04

(57) ABSTRACT

A method performed by a remote device (10) for handling communication in a wireless communications network. The remote device performs a SDT communication with a radio network node (12) via a relay device (15).

### TECHNICAL FIELD

Embodiments herein relate to a radio network node, a remote device, a relay device, and methods performed therein regarding wireless communication. Furthermore, a computer program and a computer readable storage medium are also provided herein. In particular, embodiments herein relate to handling communication in a wireless communications network. The project leading to this application has received funding from the European Union's Horizon Europe research and innovation programme under grant agreement No 101095759.

### BACKGROUND

In a typical wireless communications network, user equipments (UE), also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as new radio (NR), the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

In recent years, internet of things (IoT) has attracted much attention in the wireless communication world. More devices are expected to be interconnected for improving productivity efficiency and increasing comforts of life. Further reduction of size, complexity, and power consumption of IoT devices can enable the deployment of tens or even hundreds of billions of IoT devices for various applications and provide added value across the entire value chain. It is impossible to power all the IoT devices by battery that needs to be replaced or recharged manually, which leads to high maintenance costs, serious environmental issues, and even safety hazards for some use cases, for example, wireless sensors in electrical power, and petroleum industries.

Most of the existing wireless communication devices are powered by batteries that need to be replaced or recharged manually. The automation and digitization of various industries opens numerous new markets requiring new IoT technologies of supporting battery-less devices with no energy storage capability or devices with energy storage that do not need to be replaced or recharged manually. Ambient IoT devices may be powered by ambient sources such as wind, solar, radiation or similar.

An example type of application is asset identification, which presently has to resort mainly to barcodes and radio frequency identification (RFID) in most industries. The main advantage of these two technologies is the ultra-low complexity and small form factor of the tags identifying the assets. However, the limited reading range of a few meters usually requires handheld scanning, which leads to labor intensive and time-consuming operations, or RFID portals and/or gates which leads to costly deployments. Moreover, the lack of interference management scheme results in severe interference between RFID readers and capacity problems, especially in case of dense deployments. It is hard to support a large-scale network with seamless coverage for RFID.

In light of the above, 3GPP has defined a study item (SI) “Ambient IoT” in Release 18 to cover the scope and study relayed to such ultra-low power IoT devices which can be integrated into 3GPP networks. It is new and ongoing study and the present Technical Report (TR) 38.848 v.0.1.0 briefly specifies information related to the feasibility of meeting the design targets for relevant use cases of a new 3GPP IoT technology. This is on the basis of suitable deployment scenarios in a 3GPP system, which relies on ultra-low complexity devices with ultra-low power consumption for very-low end IoT applications. It intends to provide a clear differentiation, i.e., addressing use cases and scenarios that cannot otherwise be fulfilled based on existing 3GPP low power wide area (LPWA) IoT technology.

In terms of energy storage, the study considers the following device characteristics:
Pure battery-less devices with no energy storage capability at all, and completely dependent on the availability of an external source of energy.
Devices with a limited energy storage capability that do not need to be replaced or recharged manually.

The study investigates the feasibility of a new IoT technology to open new markets within 3GPP systems, whose number of connections and/or device density can be orders of magnitude higher than existing 3GPP IoT technologies, and which can provide complexity and power consumption orders-of-magnitude lower than existing 3GPP LPWA technologies such as narrowband (NB)-IoT and LTE-machine type communication (MTC).

### SUMMARY

As part of developing embodiments herein one or more problems was first identified.

Small Data Transmission (SDT) technologies or functionalities are extremely useful for Ambient IoT devices due to their optimization or resource allocation procedure targeting small and sporadic data transmissions. Functionalities based or inspired from SDT can help UE to conserve battery, which is the most stringent requirement for Ambient IoT devices, and such derivative functionalities would attract attention in 5G and 6G in various SIs and work items (WI) pertinent to Ambient IoT features' standardization. Table in FIG. 1 provides the summary of SDT protocols in NR.

Layer 2 Relaying Remote UE establishes a Uu RRC connection with the network via layer 2 (L2) UE-to-Network (U2N) Relay UE.

The establishment of Uu signalling radio bearer one (SRB1) and/or signalling radio bearer two (SRB2) and data radio bearer (DRB) of the L2 U2N Remote UE is subject to Uu configuration procedures for L2 UE-to-Network Relay.

The following high level connection establishment procedure shown in FIG. 2, which is a FIG. 16.12.5.1-1 in 38.300 v.17.4.0, applies to a L2 U2N Relay and L2 U2N Remote UE. Thus, FIG. 2 shows a Procedure for L2 U2N Remote UE connection establishment:
1. The L2 U2N Remote and L2 U2N Relay UE perform discovery procedure, and establish a PC5-RRC connection using the NR sidelink PC5 unicast link establishment procedure.
2. The L2 U2N Remote UE sends the first RRC message (i.e., RRCSetupRequest) for its connection establishment with gNB via the L2 U2N Relay UE, using a specified PC5 Relay RLC channel configuration. If the L2 U2N Relay UE is not in RRC_CONNECTED, it needs to do its own Uu RRC connection establishment upon reception of a message on the specified PC5 Relay RLC channel. After L2 U2N Relay UE's RRC connection establishment procedure, gNB configures SRB0 relaying Uu Relay RLC channel to the U2N Relay UE. The gNB responds with an RRCSetup message to L2 U2N Remote UE. The RRCSetup message is sent to the L2 U2N Remote UE using SRB0 relaying Uu Relay RLC channel over Uu and a specified PC5 Relay RLC channel over PC5.

### Note 1: Void.

3. The gNB and L2 U2N Relay UE perform relaying channel setup procedure over Uu. According to the configuration from gNB, the L2 U2N Relay/Remote UE establishes a PC5 Relay RLC channel for relaying of SRB1 towards the L2 U2N Remote/Relay UE over PC5.
4. The RRCSetupComplete message is sent by the L2 U2N Remote UE to the gNB via the L2 U2N Relay UE using SRB1 relaying channel over PC5 and SRB1 relaying channel configured to the L2 U2N Relay UE over Uu. Then the L2 U2N Remote UE is as in RRC_CONNECTED with the gNB.
5. The L2 U2N Remote UE and gNB establish security following the Uu security mode procedure and the security messages are forwarded through the L2 U2N Relay UE.
6. The gNB sends an RRCReconfiguration message to the L2 U2N Remote UE via the L2 U2N Relay UE, to setup the end-to-end SRB2/DRBs of the L2 U2N Remote UE. The L2 U2N Remote UE sends an RRCReconfigurationComplete message to the gNB via the L2 U2N Relay UE as a response. In addition, the gNB may configure additional Uu Relay RLC channels between the gNB and L2 U2N Relay UE, and PC5 Relay RLC channels between L2 U2N Relay UE and L2 U2N Remote UE for the relaying traffic.

### 16.12.5.2 Radio Link Failure

The L2 U2N Remote UE in RRC_CONNECTED suspends Uu RLM (as described in clause 9.2.7) when connected to the gNB via a L2 U2N Relay UE.

The L2 U2N Relay UE declares Uu Radio Link Failure (RLF) following the same criteria as described in clause 9.2.7.

After Uu RLF is declared, the L2 U2N Relay UE takes the following action on top of the actions described in clause 9.2.7:
a PC5-RRC message can be used for sending an indication to its connected L2 U2N Remote UE(s), which may trigger RRC connection re-establishment for L2 U2N Remote UE; or
indicating to upper layer to trigger PC5 unicast link release.

Upon detecting PC5 RLF, the L2 U2N Remote UE may trigger RRC connection re-establishment.

### 16.12.5.3 RRC Connection Re-Establishment

The L2 U2N Remote UE may perform the following actions during the RRC connection re-establishment procedure:
If only suitable cell(s) are available, the L2 U2N Remote UE initiates RRC re-establishment procedure towards a suitable cell;
If only suitable L2 U2N Relay UE(s) are available, the L2 U2N Remote UE initiates RRC re-establishment procedure towards a suitable relay UE's serving cell via selected suitable L2 U2N Relay;
If both a suitable cell and a suitable relay are available, the L2 U2N Remote UE can select either one to initiate RRC re-establishment procedure based on implementation.

### 16.12.5.4 RRC Connection Resume

The RRC connection resume procedure described in clause 9.2.2 is applied to L2 U2N Remote UE.

### 16.12.5.5 System Information

The in-coverage L2 U2N Remote UE is allowed to acquire any necessary SIB(s) over Uu interface irrespective of its PC5 connection to L2 U2N Relay UE. The L2 U2N Remote UE can also receive the system information from the L2 U2N Relay UE after PC5 connection establishment with L2 U2N Relay UE.

The L2 U2N Remote UE in RRC_CONNECTED can use the on-demand SIB framework as specified in TS 38.331 to request the SIB(s) via L2 U2N Relay UE. The L2 U2N Remote UE in RRC_IDLE or RRC_INACTIVE can inform L2 U2N Relay UE of its requested SIB type(s) via PC5-RRC message. Then, L2 U2N Relay UE triggers on-demand SI/SIB acquisition procedure as specified in TS38.331 according to its own RRC state (if needed) and sends the acquired SI(s)/SIB(s) to L2 U2N Remote UE via PC5-RRC message.

Any SIB that the RRC_IDLE or RRC_INACTIVE L2 U2N Remote UE has a requirement to use (e.g., for relay purpose) can be requested by the L2 U2N Remote UE (from the L2 U2N Relay UE or the network). For SIBs that have been requested by the L2 U2N Remote UE from the L2 U2N Relay UE, the L2 U2N Relay UE forwards them again in case of any update for requested SIB(s). In case of RRC_CONNECTED L2 U2N Remote UE(s), it is the responsibility of the network to send updated SIB(s) to L2 U2N Remote UE(s) when they are updated. The L2 U2N Remote UE de-configures SI request with L2 U2N Relay UE when entering into RRC_CONNECTED state. For SIB1 forwarding, for L2 U2N Remote UE, both request-based delivery (i.e., SIB1 request by the U2N Remote UE) and unsolicited forwarding are supported by L2 U2N Relay UE, of which the usage is left to L2 U2N Relay UE implementation. If SIB1 changes, for L2 U2N Remote UE in RRC_IDLE or RRC_INACTIVE, the L2 U2N Relay UE always forwards SIB1.

For the L2 U2N Remote UE in RRC_IDLE or RRC_INACTIVE, the short message over Uu interface is not forwarded by the L2 U2N Relay UE to the L2 U2N Remote UE. The L2 U2N Relay UE can forward PWS SIBs to its connected L2 U2N Remote UE(s).

RAN sharing is supported for L2 U2N Relay UE. In particular, the L2 U2N Relay UE may forward, via discovery message, cell access related information before the establishment of a PC5-RRC connection.

For a device supporting ambient IoT traffic, it will have limitations regarding its power or energy storage. Presently, in TR 38.848 v.0.1.0, it is defined as following, and the detailed characteristics and features are currently being discussed in RAN Study Item. In terms of energy storage, the study focusing ambient IoT considers the following device characteristics:
Pure battery-less devices with no energy storage capability at all, and completely dependent on the availability of an external source of energy.
Devices with limited energy storage capability that do not need to be replaced or recharged manually.
   In the last meeting [RAN Ambient IoT SI, meeting #99] companies are discussing to have two classed of storage with lower capacity is barely few uJ or mJ [RP-230105, RP-230674, RP-230301]

Ambient IoT or ultra-low power devices lack the uplink coverage where downlink coverage may or may not be a bottleneck. Hence, the uplink coverage of such devices can be improved using sidelink (SL) relaying, etc. However, the devices of being extremely low power, the existing mechanism of data transmission using relaying may not be efficient or not possible due to high power and/or energy requirement which such devices cannot fulfil.

An object herein is to provide a mechanism to handle communication of a remote device in an efficient manner in the wireless communications network.

One prospective solution may be to utilize small data transmission (SDT) mechanism or similar transmission variants due to its small energy consumption. SDT is already standardized for Uu interface but not for PC5 or relaying.

Due to limitation of the device's capabilities, where the device has no or weak UL connection to the network node, the device can reach the network node via a relay device. One of the existing relay technologies for the device to apply is SL UE to network (U2N) relay. Supporting SL U2N relay for the device can exploit the below benefits:
SL U2N relay supports quality of service (QoS) framework, which is aligned with Uu QoS framework so that the device can achieve end to end (E2E) QoS satisfaction in an efficient fashion.
The device can achieve reliable and secured transmission.

SL U2N relay has been introduced in the 3GPP specs in 3GPP Rel-17. However, SDT over SL relay is not supported yet due to SL relay was mainly designed for vehicle to everything (V2X) services and proximity services (Prose). Therefore, embodiments herein enhance SL U2N relay to support SDT for the device.

Furthermore, ambient IoT may utilize SL devices for assisting an ambient IoT UE. Four topologies have been suggested, out of which three topologies consider assisting device which can be a relay SL node and one for further study (FFS) topology which is also relay node based. See below agreements from RAN #98-e:

### Topic 4-4: Connectivity Topology

### Agreement:

Topology (1): BS↔Ambient IoT device
   NOTE 1: Includes the possibility of BS Rx and BS Tx in different BSs
Topology (2): BS↔intermediate node↔Ambient IoT device
   NOTE 1: Intermediate node can be relay, IAB, UE, repeater, etc. which is capable of ambient IoT
Topology (3): BS↔assisting node↔Ambient IoT device↔BS
   NOTE 1: Assisting node can be relay, IAB, UE, repeater, etc. which is capable of ambient IoT
   FFS: If the two BS can be different
Topology (4): UE↔Ambient IoT device
FFS: Topology (5) UE↔Ambient IoT device↔{BS or UE}
NOTE: For potential topology (5), discuss its relation with other topologies, its necessity, etc. in RAN #99.
NOTE for all topologies: The Ambient IoT device may be provided with carrier wave from another node(s) either inside or outside the topology
NOTE for all topologies: The links in each topology may be bidirectional or unidirectional
FFS: Whether to consider combination of different topologies in the study.
FFS: BS, UE, or assisting node could be multiple BSs, UEs or assisting nodes, respectively.

According to an aspect the object is achieved, according to embodiments herein, by providing a method performed by a remote device for handling communication in a wireless communications network. The remote device performs SDT communication with a radio network node via a relay device.

According to another aspect the object is achieved, according to embodiments herein, by providing a method performed by a relay device for handling communication in a wireless communications network. The relay device performs SDT communication between a remote device and a radio network node via the relay device.

According to an aspect the object is achieved, according to embodiments herein, by providing a method performed by a radio network node for handling communication in a wireless communications network. The radio network node performs SDT communication with a remote device via a relay device.

According to an aspect the object is achieved, according to embodiments herein, by providing a relay device, a remote device, and a radio network node configured to perform the methods herein, respectively.

Thus, according to an aspect the object is achieved, according to embodiments herein, by providing a remote device for handling communication in a wireless communications network. The remote device is configured to perform SDT communication with a radio network node via a relay device.

According to another aspect the object is achieved, according to embodiments herein, by providing a relay device for handling communication in a wireless communications network. The relay device is configured to perform SDT communication between a remote device and a radio network node via the relay device.

According to an aspect the object is achieved, according to embodiments herein, by providing a radio network node for handling communication in a wireless communications network. The radio network node is configured to perform SDT communication with a remote device via a relay device.

It is furthermore provided herein a computer program product comprising instructions, which, when executed on at least one processor, cause the at least one processor to carry out the methods herein, as performed by the remote device, the relay device, or the radio network node, respectively. It is additionally provided herein a computer-readable storage medium, having stored thereon a computer program product comprising instructions which, when executed on at least one processor, cause the at least one processor to carry out the method according to the methods herein, as performed by the remote device, the relay device, or the radio network node, respectively.

It is herein disclosed SDT transmission and/or reception with, e.g., strict L2 relaying and relaxed L2 relaying, i.e., reception may be over Uu instead of PC5.

The remote device, such as an ambient IoT based UE, may have limited energy storage or no storage at all. For such remote devices, the transmissions cannot happen in radio resource control (RRC) connected mode using tradition scheduling methods. It will not work for remote devices which have some capacitor as their battery or remote devices that rely on energy harvesting, radio frequency (RF) harvesting or backscattering for their transmissions. For such remote devices, the suggested SDT based mechanism provides a good opportunity to transmit in UL without getting into RRC connected mode and save energy. However, the remote devices will not have substantial UL coverage due to small energy or no energy storage, relying on backscattering. Hence, for such remote devices, SDT via relaying may be the mechanism that can help in following ways:
Increase UL coverage using relaying, and
Save energy using SDT mechanism.

Thus, the communication of a remote device is handled in an efficient manner in the wireless communications network.

### BRIEF DESCRIPTION OF THE DRAWINGS

Embodiments will now be described in more detail in relation to the enclosed drawings, in which:

FIGS. 1a-1b show a table concerning SDT;

FIG. 2 shows a procedure for L2 U2N Remote UE connection establishment;

FIG. 3 shows an overview depicting a wireless communications network according to embodiments herein;

FIG. 4 shows a combined signalling scheme and flowchart depicting embodiments herein;

FIG. 5 shows a flowchart depicting a method performed by a remote device according to embodiments herein;

FIG. 6 shows a flowchart depicting a method performed by a relay device according to embodiments herein;

FIG. 7 shows a flowchart depicting a method performed by a radio network node according to embodiments herein;

FIG. 8 shows a schematic overview depicting a remote device that transmits SDT according to some embodiments herein;

FIG. 9 shows UE assistance information signalling according to some embodiments herein;

FIG. 10 shows UE assistance information signalling according to some embodiments herein;

FIG. 11 shows a relay procedure according to some embodiments herein;

FIG. 12 shows a schematic overview depicting a remote device that transmits SDT according to some embodiments herein;

FIG. 13 shows a block diagram depicting embodiments of a remote device according to embodiments herein;

FIG. 14 shows a block diagram depicting embodiments of a relay device according to embodiments herein;

FIG. 15 shows a block diagram depicting embodiments of a remote device according to embodiments herein;

FIG. 16 schematically illustrates a telecommunication network connected via an intermediate network to a host computer;

FIG. 17 is a generalized block diagram of a host computer communicating via a base station with a user equipment over a partially wireless connection; and

FIGS. 18,19,20, and 21 are flowcharts illustrating methods implemented in a communication system including a host computer, a base station and a user equipment.

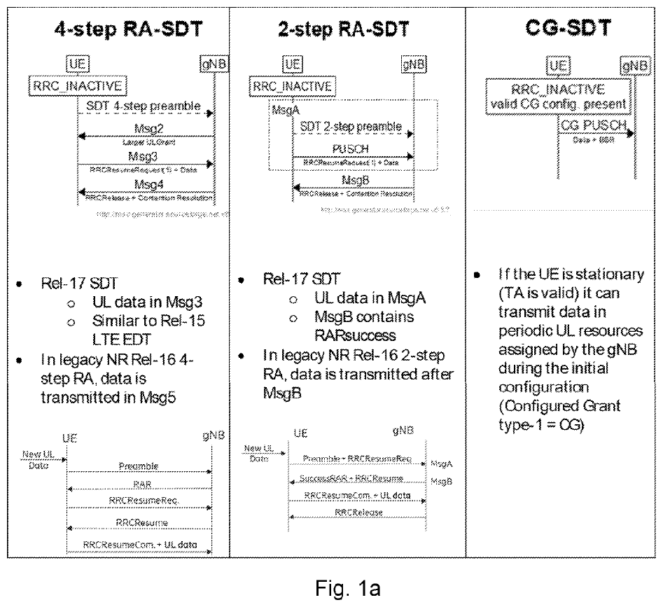

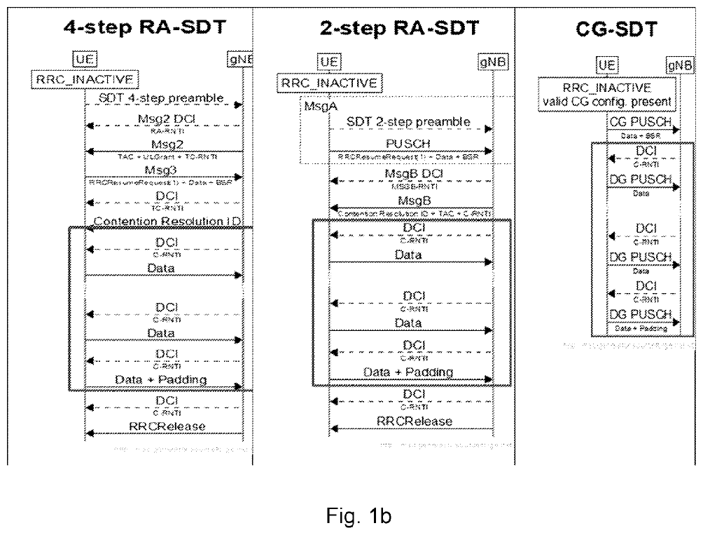

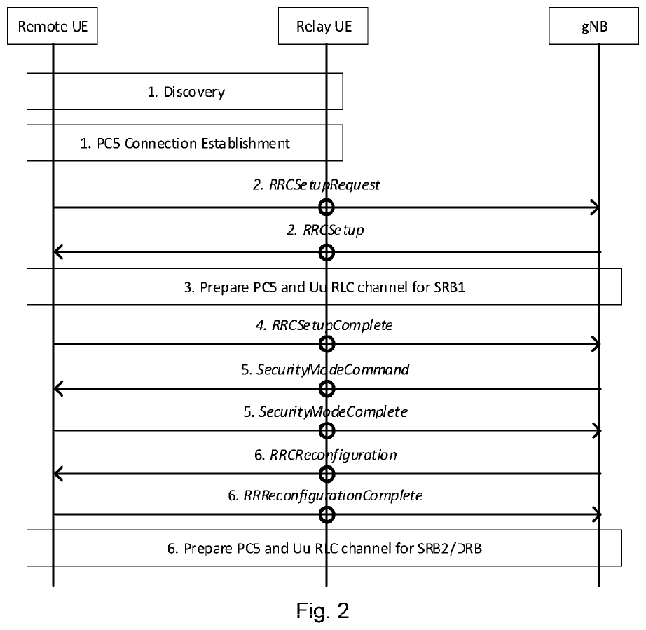

### DETAILED DESCRIPTION

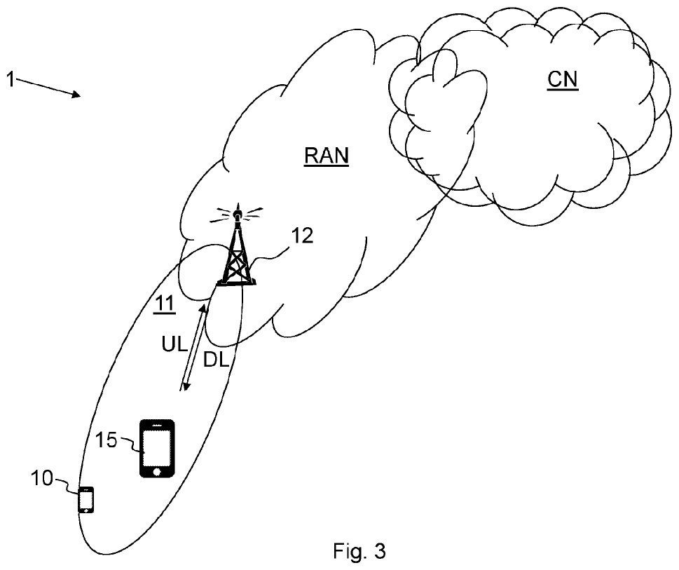

Embodiments herein relate to wireless communications networks in general. FIG. 3 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 1, a remote device 10 exemplified herein as a UE such as a wireless device such as a mobile station, a non-access point (non-AP) station (STA), a device with limited energy storage or no energy storage, an ambient internet of things (IoT) device, a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a first radio network node 12, or radio network node, providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The radio network node 12 may be referred to as the radio network node or as a serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage.

The wireless communications network 1 further comprises a relay device or node 15 such as UE or similar for operating as a relay of data and/or signalling between the radio network node 12 and the remote device 10.

According to embodiments herein the remote device 10 performs SDT communications over the relay device 15, for example, along with a RRC request pertaining to setup or resume connection. For example, the remote device 10 transmits SDT-data to the radio network node 12 via the relay device 15, and the radio network node 12 may transmit SDT data to the remote device 10 via the relay device 15, over a SL, such as over the PC5 interface, and/or directly over radio interface such as the Uu-interface.

A procedure for L2 U2N remote device connection establishment is herein suggested, the remote device 10 may transmit or perform SDT along with RRC requests pertaining to setup or resume connection. In addition, the radio network node 12 can also perform SDT to remote device 10 via L2 relaying mechanism during RRC request procedure initiated by the remote device 10. The reception at the remote device 10 may alternatively be performed over a Uu interface where transmissions are done, RRC request and SDT, over PC5 interface, this may be denoted as a partial L2 relaying mechanism.

The term “remote device” is used herein and stands for the device, such as an ambient IoT capable device, which communicates, such as transmits, small data towards the network. The term “relay device” is used herein to stand for the device which provides the relay function to the remote device, relaying the communication. The embodiments are not limited by terms. Any similar terms are interchangeably applicable here.

In embodiments herein, it is assumed that the remote device 10 communicates a single packet. However, the embodiments are not limited by this. The mechanisms covered are also applicable to the remote device 10 with multiple packets for communication.

Further, the relay device or node 15 can also be simply described as a UE (see agreed topologies in problem statement), and the link between the relay device 15 and the remote device 10 can be described as a relay link or new link or interface where embodiments herein may be applied in a non-limiting manner. However, for the description, embodiments herein use relay node terminology, and the link with the remote device 10 as a relay link.

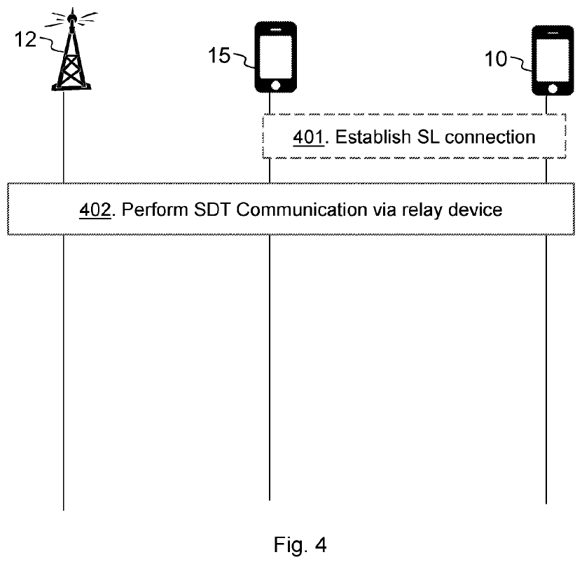

FIG. 4 is a combined signalling scheme and flowchart according to embodiments herein.

Action 401. The remote device 10 may initiate an establishment of a connection to the relay device 15. For example, the remote device 10 may establish the relay link such as an SL connection to the relay device 15.

Action 402. The remote device 10 performs SDT communication with the radio network node 12 via the relay device 15. The remote device 10 may transmit or perform SDT communication along with a RRC request pertaining to setup or resume connection.

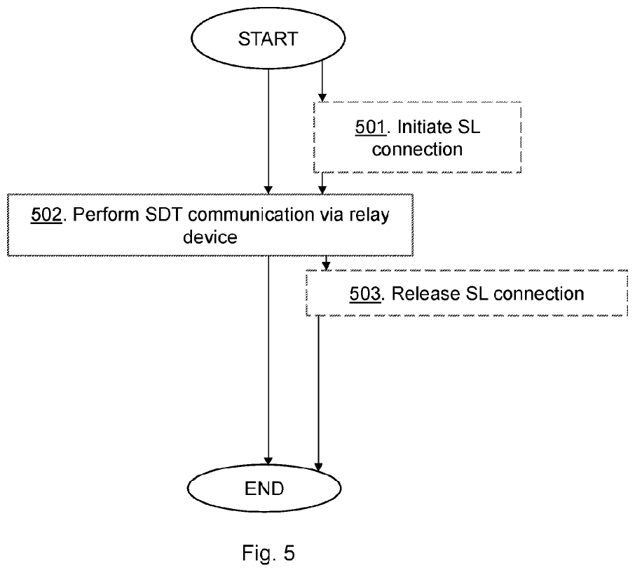

The method actions performed by the remote device 10 for handling communication in the wireless communications network according to embodiments will now be described with reference to a flowchart depicted in FIG. 5. Dashed boxes indicate optional features.

Action 501. The remote device 10 may initiate an establishment of a connection to the relay device 15. For example, the remote device 10 may establish an SL connection to the relay device 15.

Action 502. The remote device 10 performs SDT communication with the radio network node 12 via the relay device 15. The remote device 10 may perform SDT communications over the relay device 15 along with a RRC request pertaining to setup or resume a connection. For example, the remote device 10 transmits SDT data to the radio network node 12 via the relay device 15, and the radio network node 12 may transmit SDT data to the remote device 10 via the relay device 15, over the SL such as over the PC5 interface, and/or directly over a radio interface such as the Uu-interface. The remote device 10 may receive a release message with SDT from the radio network node 12 via the relay device 15.

Action 503. The remote device 10 may then release the connection to the relay device 15. For example, the remote device 10 may release the SL connection to the relay device 15.

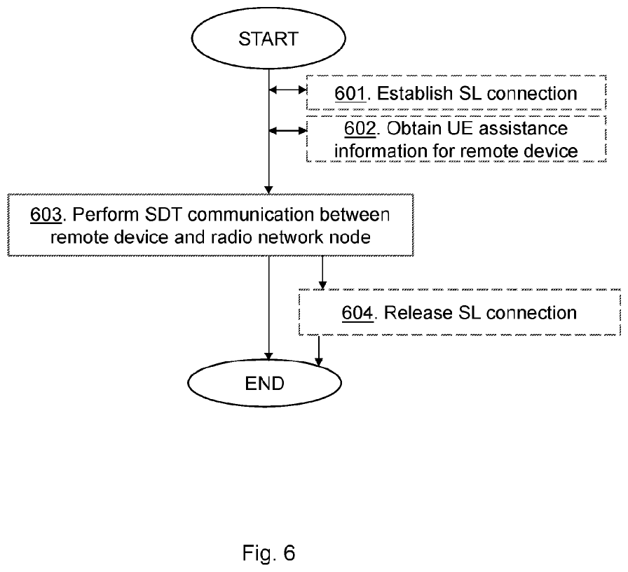

The method actions performed by the relay device 15 for handling communication in the wireless communications network according to embodiments will now be described with reference to a flowchart depicted in FIG. 6. The actions do not have to be taken in the order stated below, but may be taken in any suitable order. Dashed boxes indicate optional features.

Action 601. The relay device 15 may establish the connection to the remote device 10. For example, the remote device 10 may establish the SL connection to the relay device 15.

Action 602. The relay device 15 may obtain UE assistance information concerning the remote device 10. For example, the relay device 15 may request for the UE assistance information from the radio network node 12 for remote device ID retrieval. An assistance information request may be sent in following non-limiting-options:
Before the remote device 10 has sent its RRC request (plus data) to the radio network node 12, via the relay device 15; or
After the remote device 10 has sent its RRC request (plus data) to the relay device 15, which is yet to be forwarded to the radio network node 12; After receiving the request, the relay device 15 may send the assistance information request to the radio network node 12.

Action 603. The relay device 15 performs SDT communication between the remote device 10 and the radio network node 12 via the relay device 15. The relay device 15 may perform SDT communication between the remote device 10 and the radio network node 12 over the relay device 15 along with a RRC request pertaining to setup or resume a connection. For example, the relay device 15 may forward SDT data from the remote device 10 to the radio network node 12, and the relay device 15 may forward SDT data from the radio network node to the remote device 10, over the SL such as over the PC5 interface. The relay device 15 may forward, to the remote device 10, the release message with SDT from the radio network node 12.

Action 604. The relay device 15 may then release the connection to the remote device 10. For example, the relay device 15 may release the SL connection to the remote device 10.

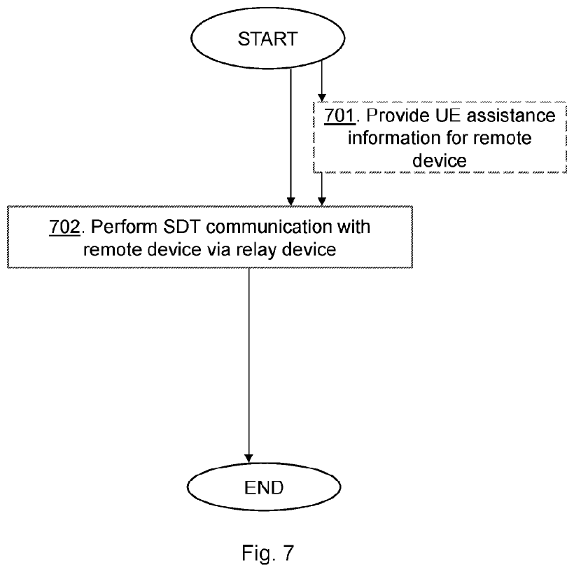

The method actions performed by the radio network node 12 for handling communication in the wireless communications network according to embodiments will now be described with reference to a flowchart depicted in FIG. 7. Dashed boxes indicate optional features.

Action 701. The radio network node 12 may provide to the relay device 15 the UE assistance information concerning the remote device 10. For example, the radio network node 12 may receive the request for the UE assistance information from the relay device 15 for remote device ID retrieval. The radio network node 12 may thus provide remote device ID to the relay device 15.

Action 702. The radio network node 12 performs SDT communication with the remote device 10 via the relay device 15. The radio network node 12 may perform SDT communications over the relay device 15 along with the RRC request pertaining to setup or resume a connection. For example, the radio network node 12 may receive SDT data from the remote device 10 via the relay device 15, and the radio network node 12 may transmit SDT data to the remote device 10 via the relay device 15, over the SL such as over the PC5 interface, and/or directly over the radio interface such as the Uu-interface. The radio network node 12 may transmit the release message with SDT to the remote device 10 via the relay device 15.

Section A: Layer 2 (L2) relaying for SDT, both transmission and reception via relay device 15.

The remote device 10 may first establish a unicast SL connection with the relay device 15, which may be selected via SL discovery procedure and PC5 interface establishment procedure. Immediately after that, the remote device 10 can send small data towards the radio network node 12 via the relay device 15 without transitioning to RRC CONNECTED, i.e., remaining in RRC IDLE or RRC INACTIVE. The SDT procedure of the remote device 10 may comprise transmission of one or multiple packets. The initial transmission may comprise at least one common control channel (CCCH) message, which may be one or both of the messages in the below:
RRCSetupRequest (if the remote device in RRC_IDLE), or
RRCResumeRequest (if the remote device is in RRC_INACTIVE)

In the initial transmission, the SDT data can be transmitted together with the CCCH message in either of both fashions in the below:
multiplexed with the CCCH message, or
embedded in the CCCH message
   with some data to the radio network node 12 via the relay device 15. After the radio network node 12 has received the SDT data, the radio network node 12 sends may send the SDT data to a network node such as a user plane function (UPF).

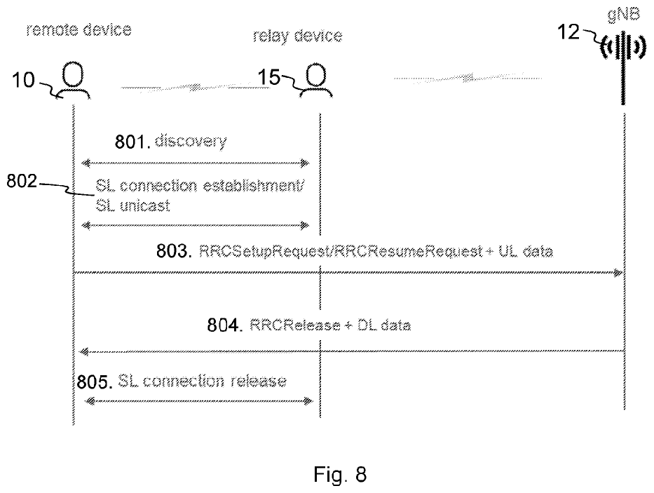

A high-level figurative description is presented in FIG. 8., which shows a Remote device 10 transmits SDT over/multiplexes with E2E SRB; and relay device 15 is in RRC CONNECTED.

Action 801. The relay device 15 and the remote device 10 may discover each other in a discovery procedure sensing one another.

Action 802. The relay device 15 and the remote device 10 may perform an SL connection establishment setting up an SL unicast.

Action 803. The remote device 10 may transmit RRCsetupRequest, or RRCResumeRequest+UL data such as SDT data to the radio network node 12 via the relay node 15.

Action 804. The radio network node 12 may transmit RRCrelease+DL data such as SDT data to the remote device 10 via the relay node 15.

Action 805. The relay device 15 and the remote device 10 may then perform an SL connection release.

For the initial SDT transmission, the remote device 10 may embed the SDT, which belongs to one or multiple data logical channels (LCH) in the SRB, e.g., SRB0, which carries the CCCH message. In this case, the SDT is added as a payload with CCCH service data unit (SDU) mapped onto the SRB. The SDT may be encapsulated as an information element (IE), which is transparent to the RRC layer so that the RRC layer doesn't decode the data part, and just forward to the application layer for decoding the data.

The SDT may belong to one or multiple data LCHs and therefore may be associated with one or multiple DRBs. Such one or multiple DRBs may be configured or pre-configured with SDT transfer. In this case, the SDUs of data LCHs and CCCH SDU may be multiplexed together in the same medium access control (MAC) protocol data unit (PDU).

When the remote device 10 is in RRC_IDLE, a default or fixed configuration for a radio bearer, such as a data radio bearer or signalling radio bearer, may be provided to the remote device 10 based on which the remote device 10 can transmit small data associated with the default radio bearer. There may be more than one configuration for default radio bearers, which makes it feasible for the remote device 10 to transmit small data belonging to multiple radio bearers. SDUs of multiple radio bearers may be multiplexed at the MAC layer to form a MAC PDU.

SDT specific configured grants may be configured for both the SL hop and the Uu hop. Configured grants for the SL hop may be configured to the remote device 10 in a system information block (SIB) if the remote device 10 is in RRC IDLE, while configured grants for the SL hop may be configured to the remote device 10 via dedicated RRC signalling, e.g., RRC Release message, if the remote device 10 transits to RRC INACTIVE from RRC CONNECTED. Configured grants for the Uu hop may be configured to the relay device 15 by the radio network node 12 via dedicated RRC signalling.

A buffer size threshold may be configured for a SDT DRB to the remote device 10 based on which the remote device 10 may determine whether to enable SDT for the DRB. In other words, the remote device 10 may perform SDT for the DRB only when the buffered data in the DRB is below the threshold. When the buffer data in the DRB is equal or above the threshold, the remote device 10 may transition to RRC CONNECTED for transmission data for the DRB.

The buffer size threshold may be configured for a SDT to the remote device 10 based on which the remote device 10 determines whether to enable SDT. The buffer size threshold may be an overall threshold for all SDT DRBs. In other words, the remote device 10 may perform SDT only when the total buffer size of all SDT DRBs is below the threshold. When the buffer data of all SDT DRBs is equal or above the threshold, the remote device 10 may transition to RRC CONNECTED for transmission data.

In the above embodiment, before forwarding the RRC requests to radio network node 12, via relay device 15, the relay device 15 may send for an assistance information including remote device SL L2 ID to the radio network node 12 and radio network node 12 may reply with a response to the relay device 15 containing a remote device Uu ID (to be utilized for SDT) of the remote device 10. It means relay device 15 may comprise a mapping between remote device SL L2 ID (use over PC5 connection between remote device and relay device 15) and remote device Uu ID (so that radio network node 12 can identify SDT data originated from the remote device). Hence, if the relay device 15 forwards remote device's SDT data to radio network node 12, it may include the remote device's Uu ID.

The relay device 15 may forward the Uu ID of the remote device 10 assigned by the radio network node 12 to the remote device 10 via PC5 signalling. After that, the remote device 10 may include the Uu ID in the data packet containing SDT, e.g., includes the Uu ID in the MAC PDU header. When the relay device 15 receives the data packet containing SDT, the relay device 15 may forward it in a transparent manner to the radio network node 12 without processing and/or reading the data packet. Upon reception of the data packet, the radio network node 12 can identify that the packet is generated by the remote device 10.

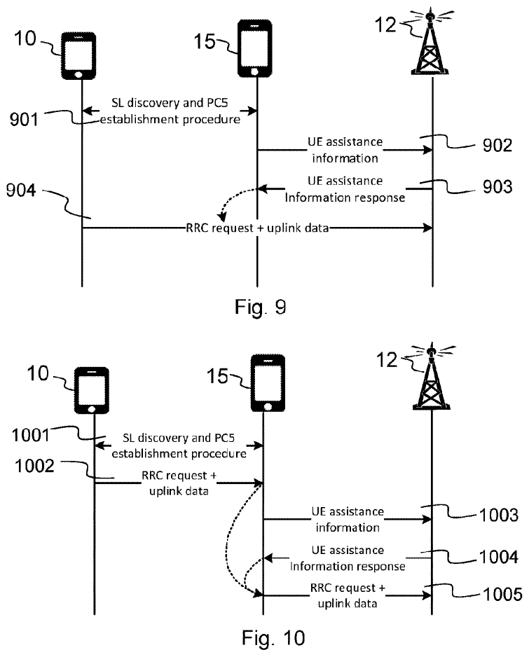

See FIG. 9 for an UE assistance information signalling request example, in which the relay device 15 sends a request for the UE assistance information concerning the remote device 10; and the radio network node 12 sends a response which may contain shorten Uu ID for usage over Uu interface.

Action 901. The remote device 10 may first establish a unicast SL connection with the relay device 15, which may be selected via SL discovery procedure and PC5 interface establishment procedure.

Action 902. The relay device 15 may then request for UE assistance information.

Action 903. The radio network node 12 transmits a UE assistance information response.

Action 904. The relay device 15 may then use the UE assistance information response for relaying RRC request with SDT data to the radio network node 12.

The radio network node 12 may provide a Cell Radio-Network Temporary Identifier (C-RNTI), which is a type of UE ID, for remote device related signalling, which may be included in the header of a data packet containing SDT generated by the remote device 10. As described in previous embodiments, the inclusion of the C-RNTI may be performed by the remote device 10 or the relay device 15. For the former, the data packet may be just forwarded by the relay device 15 to the radio network node 12 when the data packet is received by the relay device 15 from the remote device 10. For the latter, the relay device 15 includes the C-RNTI in the header of the data packet when the relay device 15 has received the data packet from the remote device 10, this means that the relay device 15 may read/process the data packet, e.g., process at least the header, when it is received from the remote device 10.

The UE assistance information request sent by relay device 15 to radio network node 12 for remote device ID retrieval may be sent in following non-limiting-options.
Before the remote device 10 has sent its RRC request (plus data) to radio network node 12 (via relay device 15), see FIG. 9.
After the remote device 10 has sent its RRC request (plus data) to relay device 15, which is yet to be forwarded to radio network node 12; After receiving the request, relay device 15 may send assistance information request to the radio network node 12, see FIG. 10

Action 1001. The remote device 10 may first establish a unicast SL connection with the relay device 15, which may be selected via SL discovery procedure and PC5 interface establishment procedure.

Action 1002. The relay device 15 may receive the RRC request from the remote device 10 and the UL data such as SDT data.

Action 1003. The relay device 15 may then request for UE assistance information. Action 1004 The radio network node 12 transmits a UE assistance information response.

Action 1005. The relay device 15 may then use the UE assistance information response for relaying the RRC request with SDT data to the radio network node 12.

FIG. 10 shows where the relay device 15 sends the request for UE assistance information concerning remote device 10 after the relay device 15 has received a request from the remote device 10 for its RRC request (including SDT) forwarding. The radio network node 12 may send a response which may contain shorten UE ID for usage over Uu interface.

Instead of a Uu ID, the relay device 15 may include same PC5 L2 UE ID in RRC requests forwarding over Uu connection. It means the radio network node 12 can understand the L2 ID of the remote device 10, i.e., radio network node 12 has context stored containing L2 ID of the remote device 10. In one embodiment, this may only be applicable for certain time period or window, and after the expiration of a timer, the remote device 10 or relay device 15:
Either must obtain an ID for the remote device 10 from radio network node 12, e.g., a Uu ID;
the remote device 10 renews or deuce its L2 UE ID and reports to the radio network node 12 via the relay device 15.

The obtained UE ID (for remote device 10) from the radio network node 12 or even the valid L2 UE ID, which radio network node 12 can understand for the remote device 10, may be needed so that remote device 10 need not to include its big UE ID, which could be based on subscription concealed identifier (SUCI), subscription permanent identifier (SUPI), Globally Unique Temporary Identifier (GUTI), temporary mobile subscriber identity (TMSI), system architecture evolution (SAE)-TMSI or S-TMSI. The reason is that the original UE ID can be very big, perhaps even larger than SDT payload, hence a much shorter UE ID may be desirable for such low power remote ambient IoT UE, as it has limited energy for data transmissions with extremely small payload. Hence, the obtained UE ID or valid L2 ID may be based on a mathematic function of SUCI, SUPI, GUTI, TMSI, S-TMSI, or new function for the identification of remote device at radio network node 12 side once it's authenticated earlier, where the UE ID is much shorter than original UE ID (SUCI, SUPI, GUTI, TMSI, S-TMSI). This UE ID, obtained ID from radio network node 12 or L2 UE ID, may be denoted as shorten new UE ID.

In one embodiment, the shorten new UE ID may be used in the RRC request related to resumption of RRC connection, e.g., remote device is in RRC Inactive state.

In the above embodiment, the data sent by the remote device 10 may originate from:
Data bearers: Some application data, IP data, etc.
Signalling bearers: some information or data related to localization, positioning, capability, security, sensing, such as joint communication and sensing, etc. In one embodiment, if the data belongs to data bearers, then following options may be applied:
An application server (AS) security may be activated or have activated before transmitting the data in the request
The AS security is or can be suspended, i.e., the radio network node 12 does not have AS security context and the data is not integrity protected
   This is fine for low power ambient devices, if the data is sporadic and consists of few bits or bytes
   The data can still have E2E application layer protection or non access stratum (NAS) protection
   The data sent with the above request may be sent over one or more of the following channels:
Dedicated traffic channel (DTCH).
CCCH
Dedicated control channel (DCCH)
   where the above channels can be multiplexed with requests or directly contain the request.
   If there is no AS security activated and no DRBs are setup, then the data, e.g., IP data, can be sent directly in the CCCH which is mapped to SRB0. This means that the SRB0 may contain requests and the data, e.g., IP data.
   Instead of SRB0, the requests may be sent over other SRBs, e.g., SRB1 or SRB2 where data can be sent in it or multiplexed.
   The small data may also be included in subsequent RRC signalling, such as RRCsetupComplete, SecurityModeComplete, RRCReconfigurationComplete. These signalling can be transmitted over SRBs depending on the level of security established, which can be SRB0, 1, 2, etc. The data may be sent directly in SRB, mapped to CCCH, or DCCH, or multiplexed, data is sent in dedicated traffic channel (DTCH).
   After the initial SDT transmission, which may need to contain at least a CCCH message, the remote device 10 can directly transmit its SDT to the radio network node 12 via the relay device 15 without inclusion of a CCCH message.
   The remote device 10 may also include buffer status report (BSR) in the transmission, which may be multiplexed or embedded within the RRC request.
   After transmitting small data, the radio network node 12 may optionally transmit DL data in a DL RRC signalling, for instance in RRCsetup, SecurityModeCommand, or RRCReconfiguration.
   The radio network node 12 may transmit small data for remote device 10 in UE assistance information response to the relay device 15, which the relay device 15 may forward to the remote device 10 over PC5 interface.
   Instead of sending RRCsetup, along with optional data, the radio network node 12 may send RRCRelease and optionally small data. After RRCRelease, the UE 10 and the radio network node 12 may not exchange anymore signalling unless there is an event triggered at the UE 10, or at the radio network node 12 or at an Access and Mobility Management Function (AMF). After an RRC release, the remote device 10 and the relay device 15 may release the SL connection for the remote device 10 to conserve the energy.
   In the signalling transmitted by the radio network node 12 to remote device 10, e.g., RRCRelease, RRCsetupRequest, or RRCResumeRequest, etc., the radio network node 12 may include feedback for SDT which is transmitted by the remote device 10 to radio network node 12. In case of non-acknowledgement (NACK), the remote device 10 may transmit the SDT again with RRC request signalling or subsequent RRC signalling or some minimal RRC signalling as the intention to retransmit the SDT.
   The remote device 10 may indicate, with an SDT indication, in the initial SDT transmission that:
      1) whether there will be subsequent SDT packets after this initial SDT transmission
      2) the total number of SDT packets or SDT transmissions, being generated by the remote device 10.
   Hence, after receiving the SDT indication, the radio network node 12 will not release the connection until a last SDT is received. The SDT indication may be
      explicit, or
         In this example, the remote device 10 can indicate the volume of data in addition to SDT, or number of SDT transmissions required from remote device side to perform full SDT, in order to empty SDT in the buffer.
      implicit.
         The implicit indication example would be, if the remote device 10 has one or more padding bits in a SDT packet, it means the remote device 10 has transmitted all the data, otherwise not. In case data remains, then the radio network node 12 will not send RRC release message unless it will receive the last transmission/packet with SDT containing padding bits in the SDT procedure.
   Further, the remote device 10 may focus on establishing the SL link such as a PC5 link with a particular relay node 15 or unicast link. Hence, the transmissions including SDT do not use any broadcast or groupcast transmission. This unicast link and/or connection may have a few benefits over broadcast/groupcast/multicast means:
      A channels state information (CSI) report may not be available for groupcast/broadcast transmissions, which makes the transmission less reliable. While CSI report is available for unicast, based on which the transmitting UE can perform link adaptation and power control towards the reporting UE.
      In the proposal (next section), the DL is performed over Uu interface directly to the remote device 10, hence, groupcast transmissions may interfere with DL transmissions to ambient IoT UEs.
      The feedback and retransmission for data transmissions over groupcast is not efficient as unicast.
Section B: Partial L2 relaying for SDT, i.e., transmission via the relay device 15, but reception occurs over Uu interface directly from the radio network node 12.
   The major difference from Section A is that for remote devices based on ambient IoT traffic can support/do DL via Uu interface but UL is done via PC5 connection.

| Ambient IoT device | Transmission | Reception |
|---|---|---|
| Based on Section A | PC5 | PC5 |
| configuration (pure L2 | | |
| relaying) | | |
| Based on Section B | PC5 | Uu |
| configuration (partial | | |
| L2 relaying) | | |

Normally a L2 relaying based remote device has some energy and/or channel quality threshold setting, e.g., configured via SIB12, which enables the remote device 10 to switch between Uu and PC5 interface for both transmission and reception altogether. However, for the remote device 10 with ambient IoT traffic, multiple configurations, for Uu and PC5, may be excessive given that the remote device 10 may be a battery-less device or its batteries are in the form of capacitors, which means their transmission powers are extremely small. Their traffic is optimized to carry few bits or bytes. One payload baseline is considered that if some UE ID is transmitted in the payload, it would be considered as the majority of the payload, it means actual meaningful data is much smaller than ID itself. For such remote device 10 a reduced signalling and configuartion overhead are strived for at all stages, whether the signalling are exchanged between device and radio network node 12 or AMF or HN, etc., as the remote devices literally don't have power/energy to deal with various kinds of transmissions or configuration overheads. Hence, for such remote devices, the network, such as the radio network node 12, may provide:
   Only reception parameters related to transmissions over Uu interface
      Receptions occur over DL.
   Transmission parameters related to transmissions over
      Uu interface, and
      Transmission is done over UL if channel conditions are good, or UE is close to radio network node 12.
      PC5 interface.
      Transmission is done over SL if Uu channel conditions are not good, or UE is not close to radio network node 12.
The radio network node 12 may only provide transmission parameters over PC5 but not any reception parameters in various RRC configurations, SIB, etc.
The messages like RRC release with or without SDT may be directly done over Uu interface.
The radio network node 12 may allocate L2 ID, which indicated in some DL signalling transmitted over Uu interface, where this L2 ID can be used by the remote device 10 for its transmission over PC5 interface.
For any SDT transmission over via PC5, the radio network node 12 may send the positive or negative feedback via DL (RRC) signalling over Uu interface.

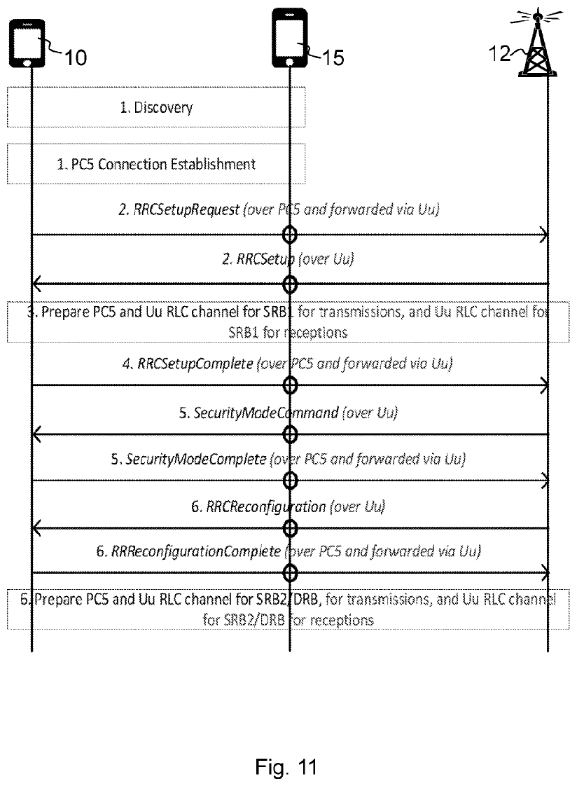

Based on Section B based configuration, the L2 device configuration procedure can be updated as shown in FIG. 11.
1. The remote device 10 and relay device 15 perform discovery procedure, and establish a PC5-RRC connection using the NR sidelink PC5 unicast link establishment procedure.
2. The remote device 10 sends the first RRC message (i.e., RRCSetupRequest) for its connection establishment with gNB over PC5 to the relay device 15, and the relay device 15 transmit the RRCSetupRequest over Uu. The radio network node 12 transmits the RRCsetup over Uu to the remote device 10.
3. Prepare PC5 and Uu RLC channel for SRB1 for transmisssions, and Uu RLC channel for SRB1 for receptions.
4. The RRCSetupComplete message is sent by the remote device 10 to the radio network node 12 via the relay node 15. The RRCSetupComplete is transmitted over PC5 to the relay node 15 and forwarded over Uu to the radio network node 12.
5. The remote device 10 and radio network node 12 establishes security following the Uu securitymodecommand procedure.
6. The radio network node 12 sends an RRCReconfiguration message to the remote device 10 over Uu. The remote device 10 sends an RRCReconfigurationComplete message to the relay device 15 that forwards the RRCReconfigurationComplete message to the radio network node 12. In addition, prepare PC5 and Uu RLC channel for SRB2/DRB for transmissions, and Uu RLC channel for SRB2/DRB for receptions.

FIG. 11 shows a Relay procedure with transmission only via L2 relaying.

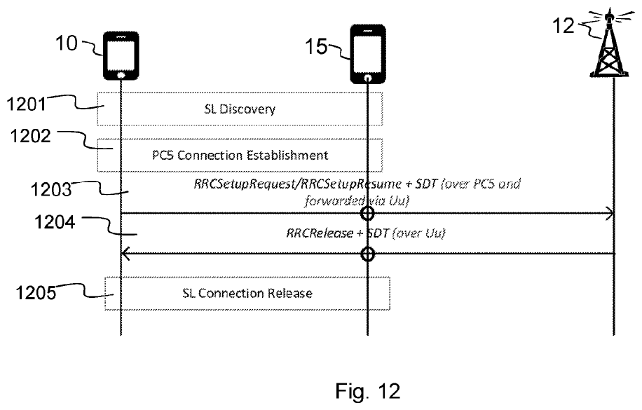

The configuration for signalling SDT, from radio network node 12, may be transmitted over any DL signalling during the RRC setup or resume procedure. Whereas SDT from the remote device 10 may be transmitted via PC5 (and forwarded over Uu) or Uu interface depending on whether the remote device 10 is connected/connecting to relay device 15 or radio network node 12. Hence, the FIG. 11 can be drawn as following in FIG. 12 for Section A. FIG. 12 shows the remote device 10 transmitting SDT over/multiplexes with E2E SRB, and the relay device 15 is in RRC CONNECTED.

Action 1201. The relay device 15 and the remote device 10 may discover each other in a discovery procedure sensing one another.

Action 1202. The relay device 15 and the remote device 10 may perform PC5 connection establishment setting up an SL unicast.

Action 1203. The remote device 10 may transmit RRCsetupRequest, or RRCResumeRequest+SDT data to the radio network node 12 via the relay node 15. Thus, the SDT data is transmitted over PC5 to the relay node 15 and forwarded over Uu to the radio network node 12.

Action 1204. The radio network node 12 may transmit RRCrelease+SDT data to the remote device 10, directly over Uu.

Action 1205. The relay device 15 and the remote device 10 may then perform a SL connection release.

The SDT receptions at the remote device 10 can be configured either via Uu interface or PC5 or both depending on channel conditions, power, load, interference, preferences, etc.
DL channel condition may be measured in terms of reference signal received power (RSRP), reference signal received quality (RSRQ), received signal strength indication (RSSI), signal to interference plus noise ratio (SINR) etc. Higher the value is, stronger/better the radio condition is.
PC5 channel condition is measured in terms of RSRP, RSRQ, RSSI, SINR etc. Higher the value is, stronger/better the radio condition is.
In an example, if DL channel condition is better than a configured threshold, the remote device 10 will only monitor physical downlink shared channel (PDSCH), physical downlink control channel (PDCCH), broadcast channel (BCH), etc.
In an example, if DL channel condition is lower/worse than a configured threshold, and PC5 channel condition is better than a configured threshold, the remote device 10 will only monitor PC5 reception channels.
In an example, when the remote device 10 monitors/receives data from the DL channel, however, the remote device 10 may also monitor some PC5 reception channels where it may receive feedback or information related to transmissions over PC5. In this case, the remote device 10 may switch between DL reception and PC5 reception according to a configuration, e.g., on time division multiplexing (TDM) pattern between DL reception and PC5 reception, if the remote device 10 only supports on reception radio chain. On the other hand, if PC5 reception channel becomes stronger, better power, power spectral density (PSD), lower path loss, etc., then the remote device 10 may switch its reception to PC5 channels completely, i.e., radio network node 12 needs to transmit information or signalling via the relay device 15.
In an example, the remote device 10 may receive information, data, SDT via both interfaces, i.e., Uu and PC5, where SDT or SDT data can be duplicated, to increase reliability, or different, to increase throughput.

The embodiments of Section A can also be applied to Section B, the only difference would be reception related signalling or transmissions occur over Uu interface directly, instead of PC5, therefore, the embodiments are repeated for sake rewriting the same logic and signalling is changed over to Uu interface.

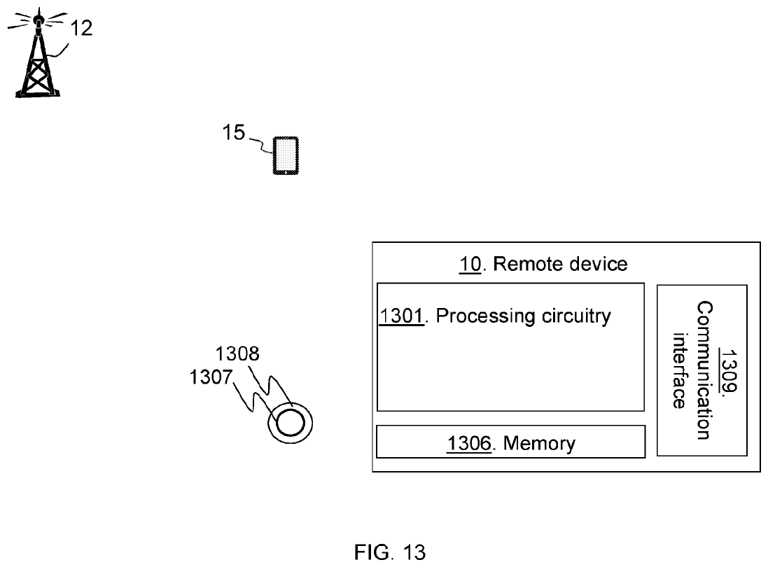

FIG. 13 is a block diagram depicting the remote device 10 for handling communication in the wireless communications network 1 according to embodiments herein.

The remote device 10 may comprise processing circuitry 1301, e.g., one or more processors, configured to perform the methods herein.

The remote device 10 and/or the processing circuitry 1301 is configured to perform SDT communication with the radio network node 12 via the relay device 15. The remote device 10 and/or the processing circuitry 1301 may be configured to perform SDT communications over the relay device 15, for example, along with a RRC request pertaining to setup or resume a connection. The remote device 10 and/or the processing circuitry 1301 may be configured to transmit SDT data to the radio network node 12 via the relay device 15, and/or the remote device 10 and/or the processing circuitry 1301 may be configured to transmit SDT data to the remote device 10 via the relay device 15, over the SL such as over the PC5 interface, and/or directly over radio interface, for example, a L3 interface such as the Uu-interface. The remote device 10 and/or the processing circuitry 1301 may be configured to receive the release message with SDT from the radio network node 12 via the relay device 15.

The remote device 10 and/or the processing circuitry 1301 may be configured to initiate the establishment of the connection to the relay device 15. For example, the remote device 10 and/or the processing circuitry 1301 may be configured to establish the SL connection to the relay device 15.

The remote device 10 and/or the processing circuitry 1301 may be configured to release the connection to the relay device 15. For example, the remote device 10 and/or the processing circuitry 1301 may be configured to release the SL connection to the relay device 15.

The remote device 10 may comprise a memory 1306. The memory 1306 comprises one or more units to be used to store data on, such as data packets, one or more conditions, mobility events, SDT data, events and applications to perform the methods disclosed herein when being executed, and similar. Furthermore, the remote device 10 may comprise a communication interface 1309 such as comprising a transmitter, a receiver, a transceiver and/or one or more antennas.

The methods according to the embodiments described herein for the remote device 10 may be respectively implemented by means of, e.g., a computer program product 1307 or a computer program, comprising instructions, i.e., software code portions, which, when executed on at least one processor, cause the at least one processor to carry out the actions described herein, as performed by the remote device 10. The computer program product 1307 may be stored on a computer-readable storage medium 1308, e.g., a disc, a universal serial bus (USB) stick or similar. The computer-readable storage medium 1308, having stored thereon the computer program product, may comprise the instructions which, when executed on at least one processor, cause the at least one processor to carry out the actions described herein, as performed by the remote device 10. In some embodiments, the computer-readable storage medium may be a transitory or a non-transitory computer-readable storage medium. Thus, embodiments herein may disclose a remote device for handling communication in a wireless communications network, wherein the remote device comprises processing circuitry and a memory, said memory comprising instructions executable by said processing circuitry whereby said remote device 10 is operative to perform any of the methods herein.

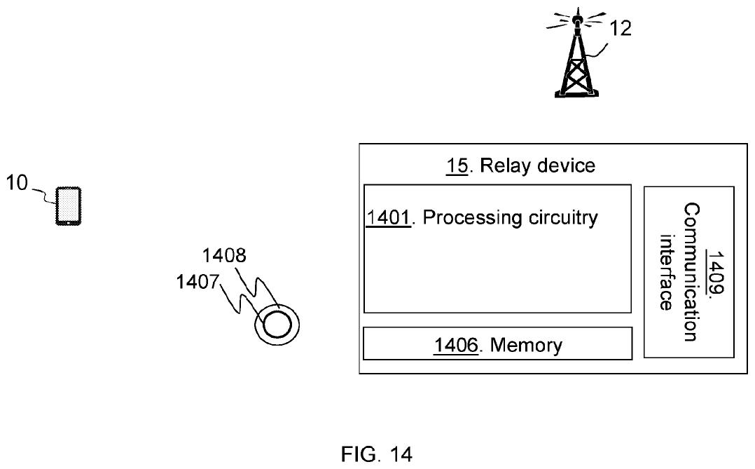

FIG. 14 is a block diagram depicting the relay device 15 for handling communication in the wireless communications network 1 according to embodiments herein.

The relay device 15 may comprise processing circuitry 1401, e.g., one or more processors, configured to perform the methods herein.

The relay device 15 and/or the processing circuitry 1401 is configured to perform SDT communication between the remote device 10 and the radio network node 12 via the relay device 15. The relay device 15 and/or the processing circuitry 1401 may be configured to perform SDT communication between the remote device 10 and the radio network node 12 over the relay device 15 along with the RRC request pertaining to setup or resume the connection. The relay device 15 and/or the processing circuitry 1401 may be configured to forward SDT data from the remote device 10 to the radio network node 12, and the relay device 15 and/or the processing circuitry 1401 may be configured to forward SDT data from the radio network node to the remote device 10, over the SL such as over the PC5 interface. The relay device 15 and/or the processing circuitry 1401 may be configured to forward, to the remote device 10, the release message with SDT from the radio network node 12.

The relay device 15 and/or the processing circuitry 1401 may be configured to establish the connection to the remote device 10. The relay device 15 and/or the processing circuitry 1401 may be configured to establish the SL connection to the relay device 15.

The relay device 15 and/or the processing circuitry 1401 may be configured to obtain the UE assistance information concerning the remote device 10. The relay device 15 and/or the processing circuitry 1401 may be configured to request the UE assistance information from the radio network node 12 for remote device ID retrieval, where this assistance information request can be sent in following non-limiting-options.
Before the remote device 10 has sent its RRC request (plus data) to radio network node 12, via relay device 15;
After the remote device 10 has sent its RRC request (plus data) to relay device 15, which is yet to be forwarded to radio network node 12; After receiving the request, relay device 15 will send assistance information request to radio network node 12.

The relay device 15 and/or the processing circuitry 1401 may be configured to release the connection to the relay device 15. For example, the relay device 15 may release the SL connection to the remote device 10.

The relay device 15 may comprise a memory 1406. The memory 1406 comprises one or more units to be used to store data on, such as data packets, one or more conditions, mobility events, SDT data, UE assistance information, events and applications to perform the methods disclosed herein when being executed, and similar. Furthermore, the relay device 15 may comprise a communication interface 1409 such as comprising a transmitter, a receiver, a transceiver and/or one or more antennas.

The methods according to the embodiments described herein for the relay device 15 may be respectively implemented by means of, e.g., a computer program product 1407 or a computer program, comprising instructions, i.e., software code portions, which, when executed on at least one processor, cause the at least one processor to carry out the actions described herein, as performed by the relay device 15. The computer program product 1407 may be stored on a computer-readable storage medium 1408, e.g., a disc, a USB stick or similar. The computer-readable storage medium 1408, having stored thereon the computer program product, may comprise the instructions which, when executed on at least one processor, cause the at least one processor to carry out the actions described herein, as performed by the relay device 15. In some embodiments, the computer-readable storage medium may be a transitory or a non-transitory computer-readable storage medium. Thus, embodiments herein may disclose a relay device 15 for handling measurement in a wireless communications network, wherein the relay device 15 comprises processing circuitry and a memory, said memory comprising instructions executable by said processing circuitry whereby said relay device 15 is operative to perform any of the methods herein.

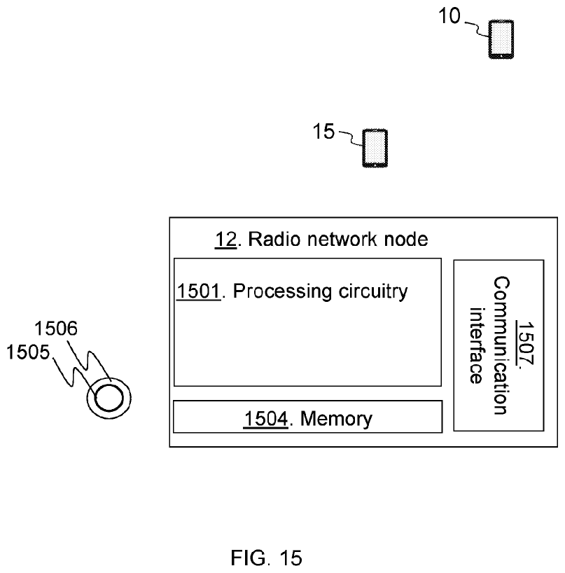

FIG. 15 is a block diagram depicting the radio network node 12 for handling communication in the wireless communications network 1 according to embodiments herein.

The radio network node 12 may comprise processing circuitry 1501, e.g., one or more processors, configured to perform the methods herein.

The radio network node 12 and/or the processing circuitry 1501 is configured to perform SDT communication with the remote device 10 via the relay device 15. The radio network node 12 and/or the processing circuitry 1501 may be configured to perform SDT communications over the relay device 15 along with the RRC request pertaining to setup or resume the connection. The radio network node 12 and/or the processing circuitry 1501 may be configured to receive SDT data from the remote device 10 via the relay device 15, and the radio network node 12 and/or the processing circuitry 1501 may be configured to transmit SDT data to the remote device 10 via the relay device 15, over the SL such as over the PC5 interface, and/or directly over radio interface such as the Uu-interface. The radio network node 12 and/or the processing circuitry 1501 may be configured to transmit the release message with SDT to the remote device 10 via the relay device 15.

The radio network node 12 and/or the processing circuitry 1501 may be configured to provide to the relay device 15 the UE assistance information concerning the remote device 10. For example, the radio network node 12 and/or the processing circuitry 501 may be configured to receive the request for the UE assistance information from the relay device 15 for remote device ID retrieval.

The radio network node 12 may comprise a memory 1504. The memory 1504 comprises one or more units to be used to store data on, such as data packets, mobility events, SDT data, UE assistance information, indications, logged measurements, configurations, events and applications to perform the methods disclosed herein when being executed, and similar. Furthermore, the radio network node 12 may comprise a communication interface 1507 such as comprising a transmitter, a receiver, a transceiver and/or one or more antennas.

The methods according to the embodiments described herein for the radio network node 12 are respectively implemented by means of, e.g., a computer program product 1505 or a computer program, comprising instructions, i.e., software code portions, which, when executed on at least one processor, cause the at least one processor to carry out the actions described herein, as performed by the radio network node 12. The computer program product 1505 may be stored on a computer-readable storage medium 1506, e.g. a disc, a universal serial bus (USB) stick or similar. The computer-readable storage medium 1506, having stored thereon the computer program product, may comprise the instructions which, when executed on at least one processor, cause the at least one processor to carry out the actions described herein, as performed by the radio network node 12. In some embodiments, the computer-readable storage medium may be a transitory or a non-transitory computer-readable storage medium. Thus, embodiments herein may disclose a radio network node 12 for handling communication in a wireless communications network, wherein the radio network node 12 comprises processing circuitry and a memory, said memory comprising instructions executable by said processing circuitry whereby said radio network node 12 is operative to perform any of the methods herein.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term the remote device and/or relay device such as a wireless device or user equipment (UE) is used and it refers to any type of wireless device communicating with a network node and/or with another wireless device in a cellular or mobile communication system. Examples of UE are target device, IoT devices, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

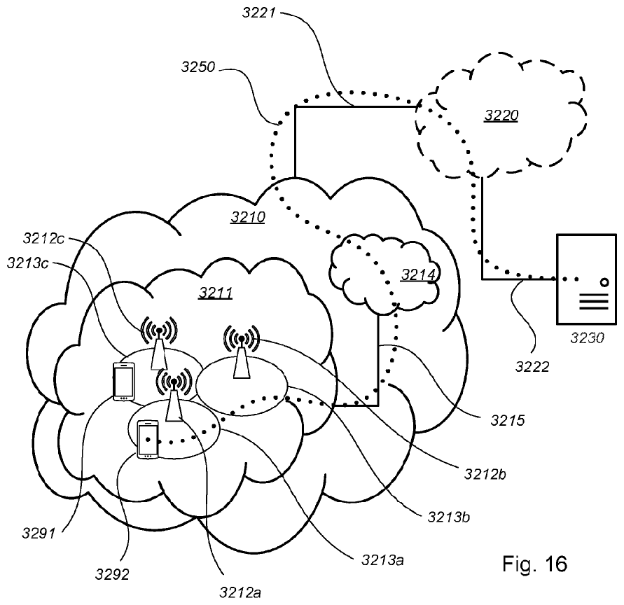

With reference to FIG. 16, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 16 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

In some embodiments, the telecommunication network 3210 includes one or more Open-RAN (ORAN) network nodes. An ORAN network node is a node in the telecommunication network 3210 that supports an ORAN specification (e.g., a specification published by the O-RAN Alliance, or any similar organization) and may operate alone or together with other nodes to implement one or more functionalities of any node in the telecommunication network 3210, including one or more network nodes and/or core network nodes.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes facilitate direct or indirect connection of user equipment (UE), such as by connecting UEs (one or more of which may be generally referred to as UEs 3291, 3292) to the core network over one or more wireless connections.

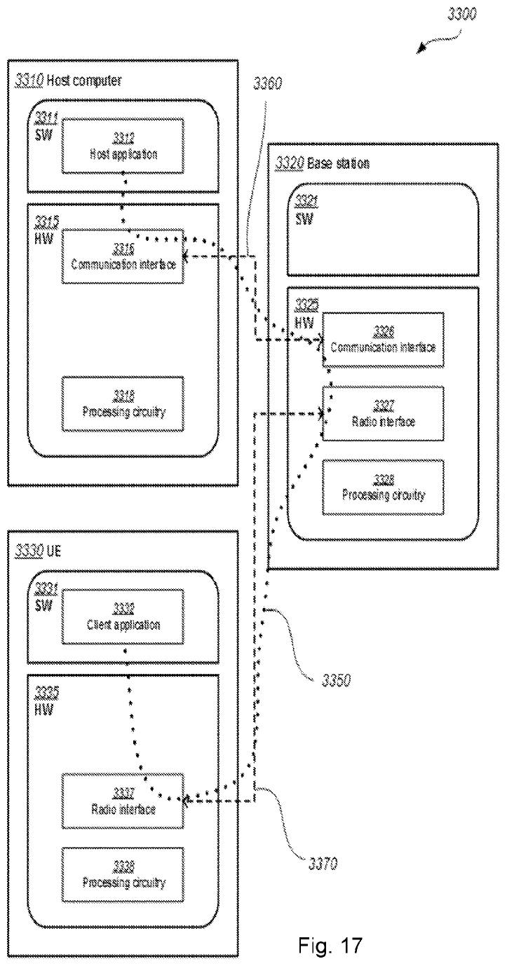

Example implementations, in accordance with an embodiment, of the UE, base station and host computer discussed in the preceding paragraphs will now be described with reference to FIG. 17. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 17) served by the base station 3320. The communication interface 3326 may be configured to facilitate a connection 3360 to the host computer 3310. The connection 3360 may be direct or it may pass through a core network (not shown in FIG. 17) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 17 may be identical to the host computer 3230, one of the base stations 3212a, 3212b, 3212c and one of the UEs 3291, 3292 of FIG. 16, respectively. This is to say, the inner workings of these entities may be as shown in FIG. 17 and independently, the surrounding network topology may be that of FIG. 16.

In FIG. 17, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since communication of remote devices may be handled efficiently (reachability and more energy efficient) and thereby provide benefits such as reduced user waiting time, better battery lifetime and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

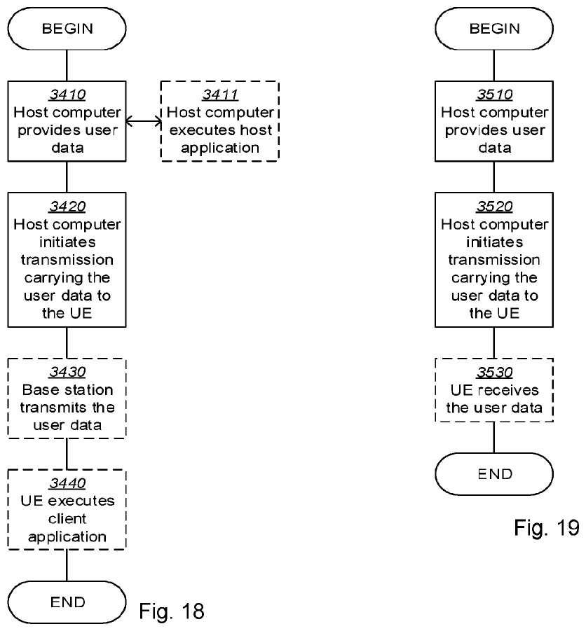

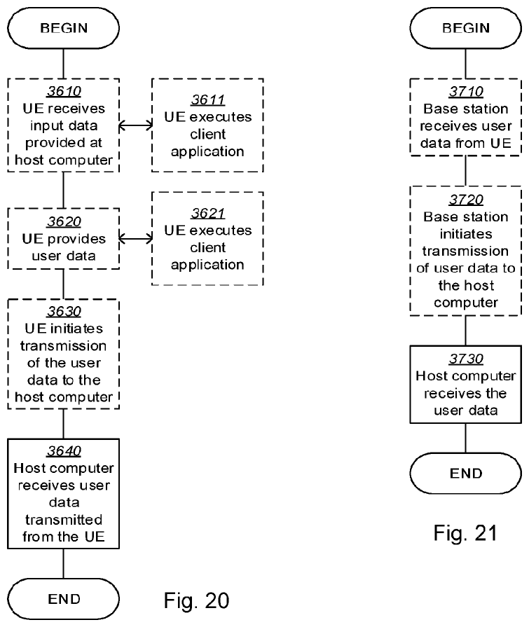

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Abbreviation Explanation

5G 5th Generation
5GC 5G Core network
AI Artificial Intelligence
AR Augmented Reality
BCH Broadcast Channel
BCCH Broadcast Control Channel
BSR Buffer Status Report
BWP Bandwidth Part
CA Carrier Aggregation
CAPC Channel Access Priority Class
CC Carrier Component
CCA Clear Channel Assessment
CCCH Common Control Channel
CCE Control Channel Element
CE Control Element
COT Channel Occupancy Time
CP Control Plane
CU Centralized Unit
CU-CP Centralized Unit-Control Plane
CU-UP Centralized Unit-User Plane
CW Contention Window
CWp Contention window for a given priority class.
CWS Contention Window Size
D2D Device to Device
DC Dual Connectivity
DCCH Dedicated Control Channel
DL Downlink
DL-SCH Downlink Shared Channel
DTCH Dedicated Traffic Channel
DU Distributed unit
E1 The interface between a gNB-CU-CP and a gNB-CU-UP in the split RAN
architecture in NR.
ED Energy Detection
eNB Evolved NodeB
EPC Evolved Packet Core
ETSI European Telecommunications Standards Institute
F1 The interface between a gNB-CU and a gNB-DU in the split RAN architecture in NR.
F1-U The user plane part of the F1 interface, e.g. the interface between a gNB-DU and a gNB-CU-UP.
FBE Frame Based Equipment
FDD Frequency Division Duplex
FPP Fixed Frame Period
GBR Guaranteed Bit Rate
gNB A radio base station in NR
gNB-CU gNB Centralized Unit
gNB-CU-CP gNB Centralized Unit Control Plane
gNB-CU-UP gNB Centralized Unit User Plane
gNB-DU gNB Distributed Unit
HO Handover
IE Information Element
IMS IP Multimedia Subsystem
IP Internet Protocol
LBE Load Based Equipment
LBT Listen-Before-Talk
LTE Long Term Evolution
MAC Medium Access Control
MCOT Maximum Channel Occupancy Time
ML Machine Learning
MLB Mobility Load Balancing
MTC Machine Type Communication
MTSI Multimedia Telephony Service for IMS
NG The interface between the RAN and the core network in 5G.
NG-RAN 5G RAN
NR New radio
NR-U NR Unlicensed (I.e. NR operated in shared (unlicensed) spectrum.)
OFDM Orthogonal Frequency Division Multiplexing
PBCH Physical Broadcast Channel
PCH Paging Channel
PCCH Paging Control Channel
PDCCH Physical Downlink Control Channel
PDCP Packet Data Convergence Protocol
PDSCH Physical Downlink Shared Channel
PDU Protocol Data Unit
PHY Physical layer
PRB Physical Resource Block
PUCCH Physical Uplink Control Channel
PUSCH Physical Uplink Shared Channel
QoS Quality of Service
RAN Radio Access Network
RAT Radio Access Technology
RLC Radio Link Control
RNL Radio Network Layer
RRC Radio Resource Control
RSRP Reference Signal Received Power
RSRQ Reference Signal Received Quality
SCS Subcarrier Spacing
SDU Service Data Unit
SINR Signal to Interference and Noise Ratio
SON Self-Organizing Network/Self-Optimizing Network
SR Scheduling Request
SSB Synchronization Signal Block
TDD Time Division Duplex
TNL Transport Network Layer
TS Technical Specification
UE User Equipment
UL Uplink
UP User Plane
URLLC Ultra-Reliable Low-Latency Communication
V2X Vehicle-to-everything (Or “Vehicle to X”, where X e.g. may be another vehicle or a network server.)
VR Virtual Reality
X2 The interface between two eNBs in LTE.
X2AP X2 Application Protocol
Xn The interface between two gNBs in NR.
XnAP Xn Application Protocol.

### EMBODIMENTS

A1. A method performed by a remote device for handling communication in a wireless communications network, the method comprising
   performing SDT communication with a radio network node via a relay device.
A2. The method according to embodiment A1, wherein performing the SDT communication is performed along with an RRC request pertaining to setup or resume a connection
A3. The method according to any of the embodiments A1-A2, wherein performing the SDT communication comprises transmitting SDT-data to the radio network node via the relay device, and receiving SDT data from the radio network node via the relay device, over a PC5 interface, and/or directly over a Uu-interface.
A4. The method according to any of the embodiments A1-A3, further comprising initiating an establishment of a connection to the relay device.
B1. A method performed by a relay device for handling communication in a wireless communications network, the method comprising
   performing SDT communication between a remote device and a radio network node via the relay device.
B2. The method according to embodiment B1, wherein performing the SDT communication is performed along with an RRC request pertaining to setup or resume a connection.
B3. The method according to any of the embodiments B1-B2, further comprising
   obtaining UE assistance information concerning the remote device.
B4. The method according to embodiment B3, wherein obtaining the UE assistance information comprises requesting the UE assistance information from the radio network node for remote device ID retrieval:
   Before the remote device has sent its RRC request to radio network node, via relay device; or.
   After the remote device has sent its RRC request to relay device.
C1. A method performed by a radio network node for handling communication in a wireless communications network; the method comprising
   performing SDT communication with a remote device via a relay device.
C2. The method according to embodiment C1, wherein performing the SDT communication is performed along with an RRC request pertaining to setup or resume a connection.
C3. The method according to any of the embodiments C1-C2, further comprising
   providing to the relay device UE assistance information concerning the remote device.
D1. A remote device for handling communication in a wireless communications network, wherein the remote device is configured to
   perform SDT communication with a radio network node via a relay device.
D2. The remote device according to embodiment D1, wherein the remote device is configured to perform the SDT communication along with an RRC request pertaining to setup or resume a connection
D3. The remote device according to any of the embodiments D1-D2, wherein the remote device is configured to perform the SDT communication by transmitting SDT-data to the radio network node via the relay device, and receiving SDT data from the radio network node via the relay device, over a PC5 interface, and/or directly over a Uu-interface.
D4. The remote device according to any of the embodiments D1-D3, wherein the remote device is configured to initiate an establishment of a connection to the relay device.
E1. A relay device for handling communication in a wireless communications network, wherein the relay device is configured to perform SDT communication between a remote device and a radio network node via the relay device.
E2. The relay device according to embodiment E1, wherein the relay device is configured to perform SDT communication along with an RRC request pertaining to setup or resume a connection.
E3. The relay device according to any of the embodiments E1-E2, wherein the relay device is configured to obtain UE assistance information concerning the remote device.
E4. The relay device according to embodiment E3, wherein the relay device is configured to obtain UE assistance information by requesting the UE assistance information from the radio network node for remote device ID retrieval:
   Before the remote device has sent its RRC request to radio network node, via relay device; or.
   After the remote device has sent its RRC request to relay device.
F1. A radio network node for handling communication in a wireless communications network; wherein the radio network node is configured to
   perform SDT communication with a remote device via a relay device.
F2. The radio network node according to embodiment F1, wherein the radio network node is configured to perform the SDT communication along with an RRC request pertaining to setup or resume a connection.
F3. The radio network node according to any of the embodiments C1-C2, wherein the radio network node is configured to provide to the relay device UE assistance information concerning the remote device.

1.-24. (canceled)

25. A method performed by a remote device for handling communication in a wireless communications network, the method comprising:
performing a small data transmission (SDT) communication with a radio network node via a relay device.

26. The method according to claim 25, wherein performing the SDT communication comprises performing the SDT communication along with a radio resource control (RRC) request pertaining to setup or resume a connection.

27. The method according to claim 25, wherein performing the SDT communication comprises transmitting SDT-data to the radio network node via the relay device, and receiving SDT data from the radio network node via the relay device, over a PC5 interface, and/or directly over a Uu-interface.

28. The method according to claim 25, further comprising initiating an establishment of a sidelink connection to the relay device.

29. A method performed by a relay device for handling communication in a wireless communications network, the method comprising:
performing a small data transmission (SDT) communication between a remote device and a radio network node via the relay device.

30. The method according to claim 29, wherein performing the SDT communication comprises performing the SDT communication along with a radio resource control (RRC) request pertaining to setup or resume a connection.

31. The method according to claim 29, further comprising obtaining user equipment (UE) assistance information concerning the remote device.

32. The method according to claim 31, wherein obtaining the UE assistance information comprises requesting for the UE assistance information from the radio network node for remote device ID retrieval:
before the remote device has sent its RRC request to the radio network node, via the relay device; or
after the remote device has sent its RRC request to the relay device.

33. A method performed by a radio network node for handling communication in a wireless communications network; the method comprising:
performing a small data transmission (SDT) communication with a remote device via a relay device.

34. The method according to claim 33, wherein performing the SDT communication comprises performing the SDT communication along with a radio resource control (RRC) request pertaining to setup or resume a connection.

35. The method according to claim 33, further comprising providing to the relay device UE assistance information concerning the remote device.

36. A remote device for handling communication in a wireless communications network, wherein the remote comprises:
processing circuitry configured to perform a small data transmission (SDT) communication with a radio network node via a relay device.

37. The remote device of claim 36, wherein the processing circuitry is configured to perform the SDT communication along with a radio resource control (RRC) request pertaining to setup or resume a connection.

38. The remote device of claim 36, wherein the processing circuitry is configured to transmit SDT-data to the radio network node via the relay device, and receive SDT data from the radio network node via the relay device, over a PC5 interface, and/or directly over a Uu-interface.

39. The remote device of claim 36, wherein the processing circuitry is further configured to initiate an establishment of a sidelink connection to the relay device.

40. A radio network node for handling communication in a wireless communications network; wherein the radio network node comprises:
processing circuitry configured to perform a small data transmission (SDT) communication with a remote device via a relay device.

41. The radio network node of claim 40, wherein the processing circuitry is configured to perform the SDT communication by performing the SDT communication along with a radio resource control (RRC) request pertaining to setup or resume a connection.

42. The radio network node of claim 40, wherein the processing circuitry is further configured to provide to the relay device UE assistance information concerning the remote device.
